(19) United States
(12) Patent Application Publication
(10) Pub. No.: US 2025/0372993 A1
(43) Pub. Date: Dec. 4, 2025

(54) SUPERCONDUCTING CABLE ASSEMBLY PROVIDED WITH ELECTRICAL BRANCH TERMINAL

(71) Applicant: NEXANS, COURBEVOIE (FR)

(72) Inventors: Nicolas LALLOUET, BAINCTHUN (FR); Arnaud ALLAIS, SAINT-RAMBERT-D'ALBON (FR); Sébastien DELPLACE, LOON-PLAGE (FR); Loïc LEGRAND, AUDRUICQ (FR)

(21) Appl. No.: 19/228,096

(22) Filed: Jun. 4, 2025

(30) Foreign Application Priority Data
Jun. 4, 2024 (FR) FR2405864

(51) Int. Cl. H02G 15/10; H01B 12/02; H01B 12/16

(52) U.S. Cl. CPC H02G 15/10; H01B 12/02; H01B 12/16

(57) ABSTRACT

A superconducting cable assembly provided with an electrical branch termina includes a junction having an electrical junction and an insulation junction having an internal wall and an external wall providing thermal insulation and defining a connection chamber wherein said electrical junction is located. Said electrical branch terminal is connected to said electrical junction by an electrical connection passing through said insulation junction. The electrical connection includes an internal conductive part located in the internal wall of the insulation junction and an external conductive part located in the external wall of the insulation junction. The internal conductive part is connected to the electrical junction and to the external conductive part by flexible electrical connection devices.

### TECHNICAL FIELD AND TECHNOLOGICAL BACKGROUND

The present invention relates to a superconducting cable assembly provided with an electrical branch terminal and an electrical system comprising the assembly.

Superconducting cables make it possible to transport electrical currents, in particular, of high strength, with cable sections which are much smaller than those of conventional transport cables composed of resistive electrical conductors, while limiting electrical losses along the cable, in particular, losses by the Joule effect, since this phenomenon is non-existent in the superconducting state.

Renewable energy sources, such as photovoltaic panels or wind turbines, and fuel cells, are fostering interest for a transition in power generation. However, the energy generated per unit of energy production is relatively low. Proposals have thus been made to operate a large number of such generators in conjunction with one another. In view of connecting these many generators with an electrical network, superconducting cables are considered as effective in transmitting the energy generated with high current and low electrical losses.

To collect the energy produced by several generators in a single superconducting cable, the latter must be provided with several branch terminals each needing to be connected to the resistive cable connected to a respective generator.

Patent application publication JP2001006837 is known that describes superconducting cable branching structure, wherein the ends of two cable lengths are introduced at opposite ends of a vacuum enclosure for an electrical connection between both of the cable length ends and a branch terminal. The branch structure is crimped on the electrical connection between both of the cable lengths, making it sensitive to variations in cable length size or position, for example, due to a temperature change or manipulation of any of the cable lengths.

There is thus a need for a superconducting cable branch structure that allows improved management of thermomechanical stresses related to the use of cryogenics.

### SUMMARY OF THE INVENTION

To this end, the invention proposes a superconducting cable assembly provided with an electrical branch terminal,
said assembly comprising a first cable length and a second cable length, each cable length coaxially comprising a superconducting element, a cryostat, a screen, an external enclosure defined by an internal wall and an external wall, and providing thermal insulation,
   said assembly further comprising a cable junction comprising:
an electrical junction providing an electrical connection of the superconducting elements of the first cable length and the second cable length,
an insulation junction comprising an internal wall and an external providing thermal insulation, said insulation junction defining a connection chamber wherein said electrical junction is located,
   said electrical branch terminal being located on an external surface of the insulation junction and being connected to said electrical junction by an electrical connection sealingly passing through said insulation junction;
   the electrical connection comprising an internal conductive part located in the internal wall of the insulation junction and an external conductive part located in the external wall of the insulation junction, the internal conductive part being connected, on the one hand, to the electrical junction by a flexible electrical connection device extending through the connection chamber, and, on the other hand, to the external conductive part by a flexible electrical connection device extending between the internal wall and the external wall of the insulation junction.

Thanks to its architecture, the cable assembly according to the invention makes it possible to branch off the superconducting cable at the resilient junction between both of the cable. The flexible electrical connection devices make it possible to absorb any variation in the size or position of the cable lengths.

According to one embodiment, the internal conductive portion, respectively the external conductive part, of the electrical connection are ring-shaped; the internal wall of the insulation junction, respectively the external wall of the insulation junction, comprising an electrically insulating part on either side of the ring.

In one embodiment, the screens of the first cable length and the second cable length are electrically connected to the insulation junction.

In one embodiment, the assembly comprises at least one secondary branch terminal located on the external surface of the insulation junction and connected to the screen of the first cable length or to the screen of the second cable length by an electrical connection sealingly passing through said insulation junction.

According to one embodiment, the internal wall of the insulation junction connects the internal walls of the external enclosures of the first and second cable lengths and the external wall of the insulation junction connects the external walls of the external enclosures of the first and second cable lengths, so as to provide a continuous connection between the external enclosures of the first cable length and the second cable length.

According to one embodiment, the assembly comprises a plurality of first cable lengths and a plurality of second cable lengths connected respectively by the cable junction,

the connection chamber of the insulation junction comprising a plurality of electrical junctions respectively connecting one of the plurality of first cable lengths with one of the plurality of second cable lengths.

According to a variant, each cable length has its own external enclosure, or the first cable lengths have a common external enclosure and the second cable lengths have a common external enclosure.

According to one embodiment, the cable junction comprises a cryostat comprising said connection chamber,
said connection chamber being in fluidic connection with the cryostat of one among the first cable length and the second cable length, a sealed wall insulating said connection chamber of the cryostat from the other cable length,
a first cooling fluid interface port being located on one side of the sealed wall and passing through the insulation junction to open out into the connection chamber,
a second cooling fluid interface port being located on the other side of the sealed wall and passing through the insulation junction for a fluidic relationship with the cryostat of the other cable length.

The invention also relates to an electronic system comprising:
one or more superconducting cable assemblies provided with a branch terminal according to any one of the preceding claims, said cable assemblies being in series;
one or more items of electrical equipment, respectively connected to a branch terminal of the superconducting cable assembly/assemblies, the electrical equipment being, in particular, one or more sources of renewable energy.

### BRIEF DESCRIPTION OF THE FIGURES

The following description given with reference to the appended drawings, provided by way of non-limiting example, will clearly explain in what the invention consists and how it may be carried out. In the attached figures:

FIG. 1 shows a first example of a cable assembly provided with a branch terminal;

FIG. 2 shows a second example of a cable assembly provided with a branch terminal;

FIG. 3 shows a third example of a cable assembly provided with a branch terminal;

FIG. 4 shows a fourth example of a cable assembly provided with a branch terminal;

FIG. 5 shows a fifth example of a cable assembly provided with a branch terminal;

FIG. 6 shows a s sixth example of a cable assembly provided with a branch terminal;

FIG. 7 shows a seventh example of a cable assembly provided with a branch terminal;

FIG. 8 shows an eighth example of a cable assembly provided with a branch terminal;

FIG. 9 shows a ninth example of a cable assembly provided with a branch terminal;

FIG. 10 shows a ninth example of a cable assembly provided with a branch terminal;

FIG. 11 shows an eleventh example of a cable assembly provided with a branch terminal;

FIG. 12 shows an electrical system comprising an example of a cable assembly provided with a branch terminal.

### DETAILED DESCRIPTION

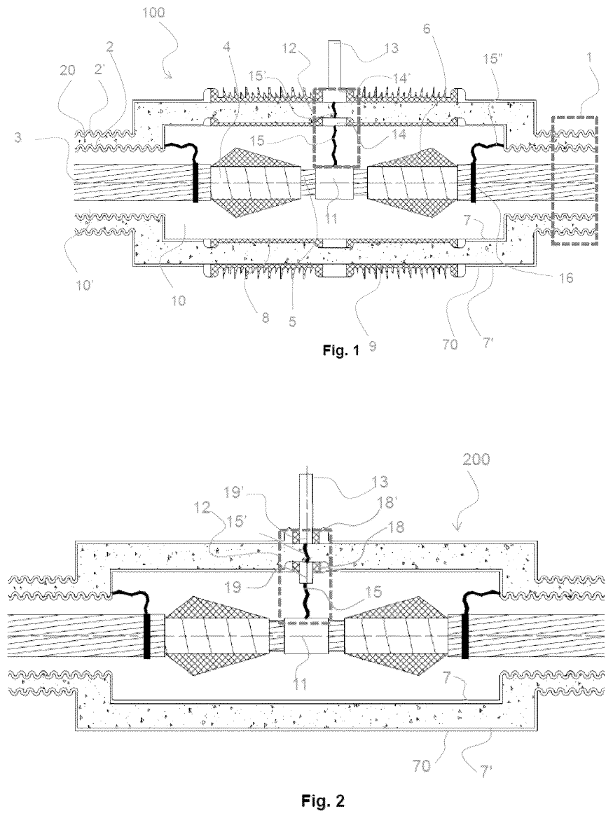

A first example 100 of a superconducting cable assembly provided with an electrical branch terminal 13 will be described with reference to FIG. 1.

The assembly 100 comprises a first cable length 1 and second cable length 1. Each cable length 1 coaxially comprises a superconducting element 5, cryostat 10′, screen 3, external enclosure 20 defined by an internal wall 2 and an external wall 2′. The external enclosure 20 provides thermal insulation.

The superconducting cable assembly 100 further comprises a cable junction that comprises an electrical junction 11. The electrical junction 11 provides an electrical connection of the superconducting elements 5 of the first cable length 1 and of the second cable length 1. The electrical junction 11 is for example, sleeve-shaped, in particular, made of copper, wherein the end of the superconducting element 5 of the first cable length 1 and the end of the superconducting element 5 of the second cable length 1 are engaged, and in particular, brazed with a tin alloy.

The assembly 100 also comprises an insulation junction 70 that provides thermal insulation. The insulation junction 70 comprises an internal wall 7 and an external wall 7′ which define a connection chamber 10 wherein the electrical junction 11 is located.

The electrical branch terminal 13 is located in an external surface of the insulation junction 70. It is connected to the electrical junction 11 by an electrical connection 12 sealingly passing through the insulation junction 70. The electrical branch terminal 13 makes it possible to introduce current into the superconducting element 5 of the superconducting cable or to extract current therefrom, in particular, from or to an electrical generator, in particular, a renewable energy source. The electrical branch terminal 13 and the electrical connection 12 are preferably made of a material with good electrical conductivity, for example, copper or aluminium.

The electrical connection 12 comprises an internal conductive part 14 located in the internal wall 7 of the insulation junction 70 and an external conductive part 14′ located in the external wall 7′ of the insulation junction 70. The internal conductive part is connected, on the one hand, to the electrical junction 11 by an electrical connection device 15 extending through the connection chamber 10. On the other hand, the internal conductive part is connected to the external conductive part by an electrical connection device 15′ extending between the internal wall 7 and the external wall 7′ of the insulation junction 70. The electrical connection devices 15, 15′ are flexible to provide an electrical connection without any mechanical or thermomechanical stress(es). For example, each electrical connection device 15, 15′ is a flexible electrical conductor, in particular, in the form of wire, copper mesh, conductive braid, contact leaf spring device, or the like.

In particular, the internal and external conductive portions of the electrical connection 12 are each surrounded in their respective wall 7, 7′ by an electrically insulating portion, and are preferably fixed mechanically and sealingly to them. For example, the electrically insulating part is made of ceramic, epoxy resin, etc.

In particular, the external walls 2′, 7′ of the external enclosures 20 of the first cable length 1, the second cable length 1 and the insulation junction 70 each have external surfaces at ambient temperature.

In particular, the internal walls 2, 7 of the external enclosures 20 of the first cable length 1, of the second cable length 1 and of the insulation junction 70 each have internal surfaces at the temperature of the cryogenic fluid used, for example, approximately −200° C., for liquid nitrogen.

In particular, each cable length 1 comprises an electrically insulating layer 4 between the superconducting element 5 and the screen 3.

In particular, each cable length 1 comprises a device 6 for managing the electric field. The device 6 makes it possible to avoid an electrical breakdown between the screen 3, at earth potential, and the superconducting element 5 at the operating voltage of the system to which the superconducting cable assembly 100 is attached. For example, the device 6 is cone-shaped and extends around the insulating layer 4 on a stripped portion thereof, between the stripped end of the superconducting element 5 and the end of the screen 3.

In particular, the internal wall 7 of the insulation junction 70 connects the internal walls 2 of the external enclosures 20 of the first cable length 1 and of the second cable length 1; and the external wall 7′ of the insulation junction 70 connects the external walls 2′ of the external enclosures 20 of the first cable length 1 and of the second cable length 1. The internal wall 7 and external wall 7′ of the insulation junction 70 then provide a continuous connection between the external enclosures 20 of the first cable length 1 and of the second cable length 1. By providing a continuous connection between the external enclosures of the first cable length and the second cable length, the insulation junction 70 makes it possible, for example, to avoid any rupture(s) in the space between the first cable length and the second cable length. The space in both of these cable lengths may then be obtained with a single device.

Alternatively, the external enclosures 20 of the first cable length 1 and of the second cable length 1 are each closed at their respective ends.

The first example 100 is according to a first embodiment wherein the internal conductive part 14 of the electrical connection 12 is ring-shaped. The internal wall 7 of the insulation junction 70 comprises an electrically insulating part 8 on either side of the ring 14. The external conductive part 14′ of the electrical connection 12 is ring-shaped. The external wall 7 of the insulation junction 70 comprises an electrically insulating part 9 on either side of the ring 14. The electrically insulating parts 8, 9 may be relatively long to increase the electrical insulation between an electrical potential of the branch terminal 13 and an electrical potential to which the rest of the respective wall 7, 7′ is connected. Thus, the first embodiment is particularly suitable for applications within the field of high voltage. Annular seals may be used around each ring to ensure a sealing with the insulating parts. However, in the invention, the electrical connection 12 may be different, in particular, as in a second embodiment described below.

In particular, the electrical branch terminal 13 is integral with the external conductive part 14′. In particular, the branch terminal 13 extends from an angular portion of the ring-shaped external conductive part 14′.

In particular, the first example 100 is according to a third embodiment wherein the screens 3 of the first cable length 1 and of the second cable length 1 are electrically connected to the insulation junction 70. In particular, the electrical connection is made by a ring 16 extending around the screen 3 and connected to it, and an electrical conductor 15″ connecting the ring 16 to the internal wall 7 of the insulation junction 70. The electrical conductor 15′' is preferably a flexible conductor such as a wire, conductive braid or a contact spring blade device. This type of electrical connection makes it possible to place the screen 3 at the same electrical potential as the internal wall 7 of the insulation junction 70. The internal wall 7 of the insulation junction 70 may also be connected to an electrical earth. In particular, thanks to the electrically insulating portions 8, 9, the earthing may be different between the first cable length 1 and the second cable length 1. However, the electrical connection between the screens 3 of both of the cable lengths 1 and the insulation junction 70 may be different. Alternatively, the cable assembly according to the invention may be devoid of an electrical connection between the screen 3 and the electrical insulation junction 70, in particular, between the part of the screen 3 comprised in the cable junction and the insulation junction 70.

FIG. 2 shows a second example 200 of a superconducting cable assembly provided with an electrical branch terminal 13. The second example of a cable assembly 200 is identical to the first example 100, except that it is according to a second embodiment wherein the internal conductive part 19 of the electrical connection 12 is rod-shaped passing through the internal wall 7 of the insulation junction 70. The internal wall 7 of the insulation junction 70 comprises an electrically insulating part 18 that extends around the rod. Furthermore, the external conductive part 19′ of the electrical connection 12 is rod-shaped passing through the external wall 7′ of the insulation junction 70. The external wall 7′ of the insulation junction 70 comprises an electrically insulating part 18′ that extends around the rod. In particular, the electrical branch terminal 13 is integral with the external conductive part 19′.

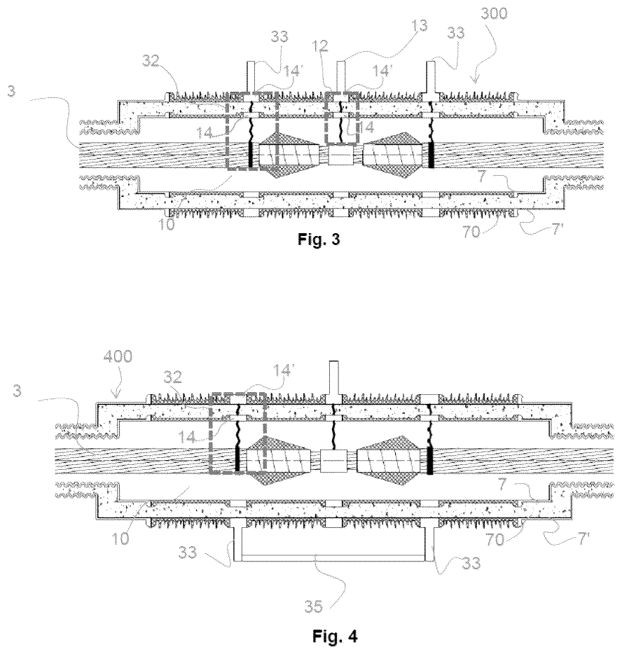

FIG. 3 shows a third example 300 of a superconducting cable assembly provided with an electrical branch terminal 13. The third example of a cable assembly 300 is identical to the first example 100, except that it is in a fourth embodiment comprising at least one secondary branch terminal 33 located on the external surface of the insulation junction 70. A secondary branch terminal 33 is connected to the screen 3 of the first cable length 1 by an electrical connection 32 sealingly passing through the insulation junction 70. Likewise, another secondary branch terminal 33 is connected to the screen 3 of the second cable length 1. The secondary branch terminal 33 makes it possible to introduce current into the screen 3 of the cable length or to extract current therefrom, for example, for connecting to an electrical earth. The electrical connection 32 is also identical to the electrical connection 12 of the branch terminal 13 described above, referred to by contrast as the “main branch terminal”.

The third example 300 furthermore is according to the first embodiment, the electrical connections 12, 32 of the main branch terminal 13 and of the secondary branch terminal 33 being identical. In general, the branch terminal 13, 33 may be located at an angular position of the ring-shaped external conductor part 14′ that is different from the angular position of the electrical connection 12, 32. This is particularly the case in a fourth example 400 shown in FIG. 4, that is also identical to the third example 300.

In particular, the secondary branch terminals 33 may be electrically connected to one another, e.g., by an electrical conductor 35. In particular, the electrical conductor 35 extends outside of the insulation junction 70, between the secondary branch terminals 33. However, the electrical connection between the secondary branch terminals 33 may be performed otherwise, for example, by a conductor extending inside of the connection chamber 10, between the internal conductive portions 14 of the electrical connections 32 of the secondary branch terminals 33. In particular, the electrical connection between the secondary branch terminals 33 makes it possible to have the same earthing connection between both of the lengths of superconducting cable 1.

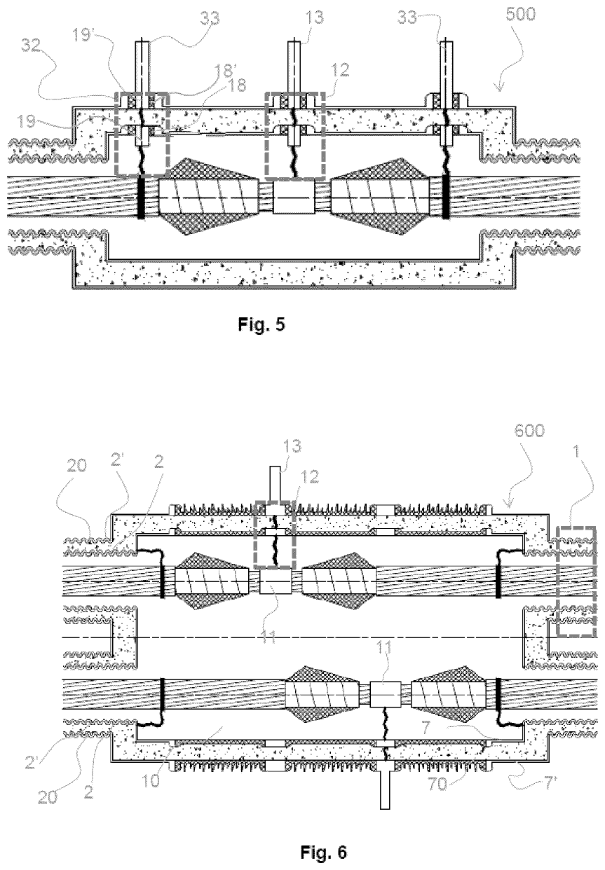

FIG. 5 shows a fifth example 500 of a superconducting cable assembly provided with an electrical branch terminal 13. The fifth example 500 of the cable assembly is identical to the third example 300, except that it is according to the second embodiment, the electrical connections 12, 32 being identical.

In particular, the branch terminals 13, 33 may or may not be aligned with one another.

FIG. 6 shows a sixth example 600 of a superconducting cable assembly according to a fifth embodiment that comprises several first cable lengths 1 (particularly located to the left in FIG. 6) and several second cable lengths 1 (particularly located to the right in FIG. 6) respectively connected by the cable junction. The connection chamber 10 of the insulation junction 70 comprises several electrical junctions 11 respectively connecting one of the first cable lengths 1 with one of the second cable lengths 1.

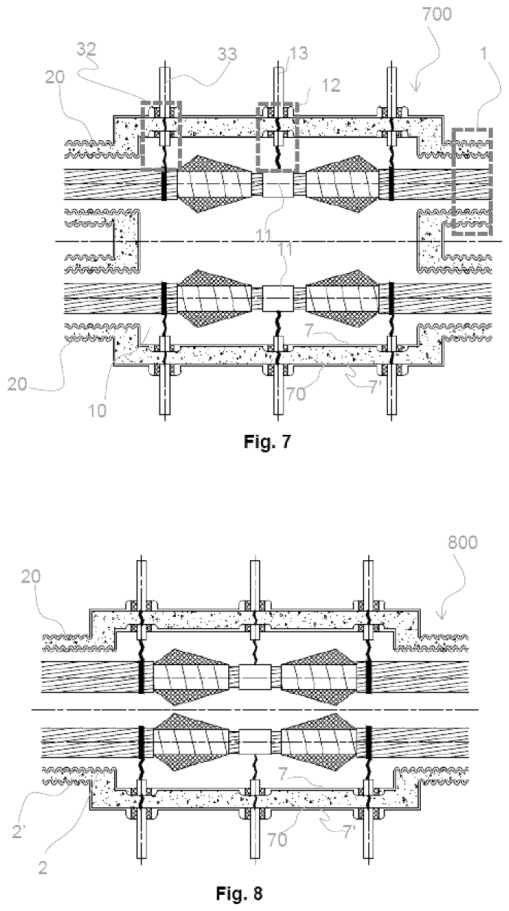

The fifth embodiment is compatible with the embodiments described previously. In particular, the sixth example 600 furthermore is according to the first embodiment. FIG. 7 shows a example 700 of a superconducting cable assembly in the fifth embodiment. In particular, the seventh example 700 is also according to the second embodiment. Both the seventh example 700, and the sixth example 600, may comprise secondary branch terminals 33 according to the fourth embodiment.

In particular, the sixth example 600 and seventh example 700 are according to a first variant of the fifth embodiment, wherein each cable length 1 has its own external enclosure 20.

FIG. 8 shows an eighth example 800 of a cable assembly according to a second variant of the fifth embodiment, wherein the first cable lengths 1 have a common external enclosure 20 and the second cable lengths 1 have a common external enclosure 20. The eighth example 800 of a cable assembly is also identical to the seventh example 700.

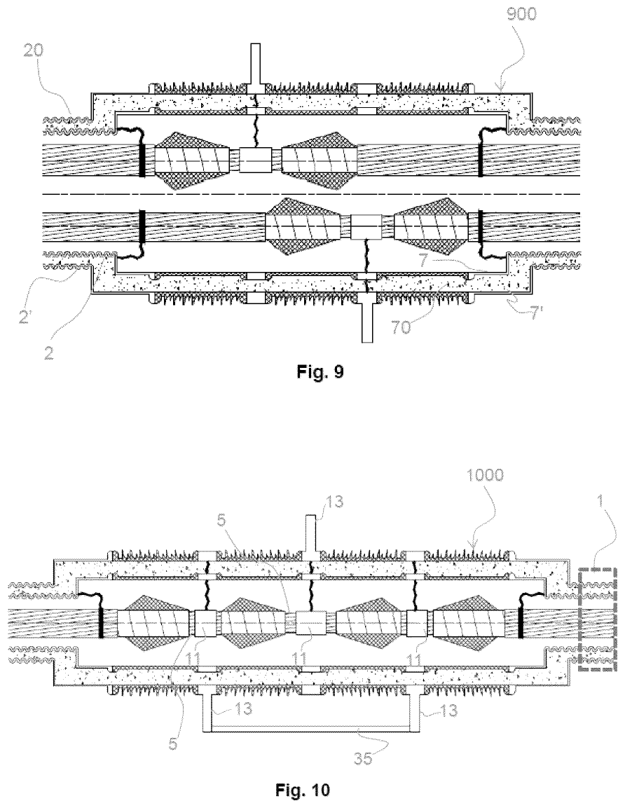

FIG. 9 shows a ninth example 900 of a cable assembly according to the second variant of the fifth embodiment, wherein the first cable lengths 1 have a common external enclosure 20 and the second cable lengths 1 have a common external enclosure 20. The ninth example 900 of a cable assembly is also identical to the sixth example 600.

In particular, in the two variants of the fifth embodiment, the internal walls 2 of the external enclosures 20 of the cable lengths 1 are connected to the internal wall 7 of the insulation junction 70; and the external walls 7′ of the external enclosures 20 of the cable lengths 1 are connected to the external wall 7′ of the insulation junction 70.

FIG. 10 shows a tenth example 1000 according to a sixth embodiment wherein the first cable length 1 and the second cable length 1 each contain several coaxial superconducting elements 5. In particular, each superconducting element 5 corresponds to one phase of a polyphase electrical signal transported by the cable. Alternatively, a first superconducting element 5 of the cable length 1 corresponds to a negative potential of a continuous electrical signal; a second superconducting element 5 of the cable length 1 corresponds to a positive potential of a continuous electrical signal. The most central superconducting elements 5 of the first and second cable length 1 are connected to one another directly by the electrical junction 11 connecting them. The peripheral superconducting elements 5 are connected to one another via their respective branch terminals 13, in particular, by an electrical conductor 35. In particular, the electrical conductor 35 extends outside of the insulation junction 70 between the branch terminals 13. However, the electrical connection between the branch terminals 13 may be performed otherwise, for example, by a conductor extending inside of the connection chamber 10, between the internal conductive portions 14 of the electrical connections 12 of the branch terminals 13.

The sixth embodiment is compatible with the embodiments previously described. In particular, the tenth example 1000 furthermore is according to the first embodiment and the third embodiment.

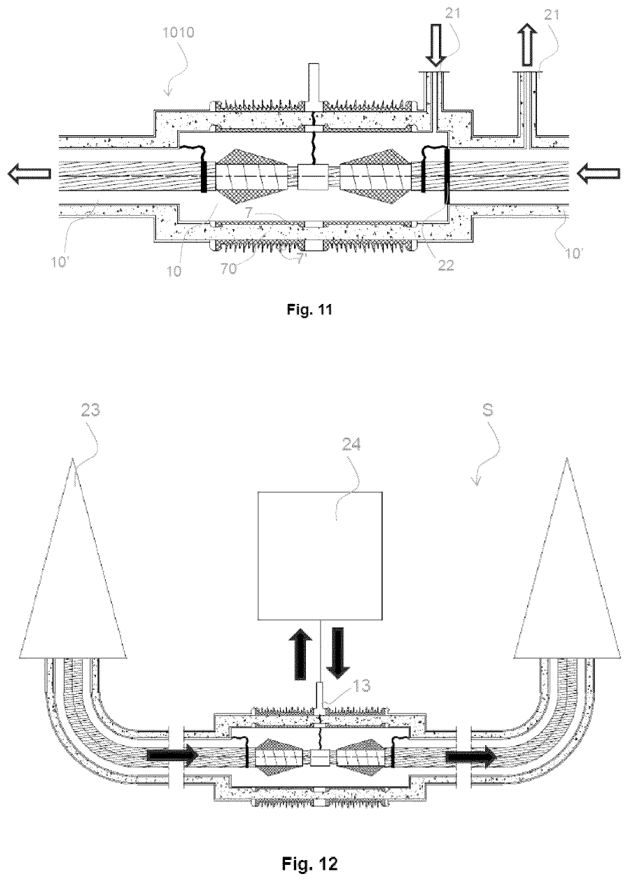

FIG. 11 shows an eleventh example 1010 according to a seventh embodiment compatible with the others. The connection chamber 10 of the insulation junction 70 forms, at least partially, a cryostat configured to receive a cooling fluid. The connection chamber 10 is in fluidic connection with the cryostat 10′ of the first cable length 1, particularly located on the left in FIG. 11. A sealed wall 22 insulates the connection chamber 10 of the cryostat 10′ from the other cable length. A first cooling fluid interface port 21 is located on one side of the sealed wall 22. The first interface port 21 passes through the insulation junction 70 to open out into the connection chamber 10. 1 second cooling fluid interface port 21 is located on the other side of the sealed wall 22. The second interface port 21 passes through the insulation junction 70 to be in fluidic relationship with the cryostat 10′ of the other cable length.

In particular, the interface ports 21 are located on the external surface of the insulation junction 70. For example, the first interface port 21 and the second interface port 21 respectively form a cooling fluid inlet and a cooling fluid outlet, or vice-versa. In particular, the cooling fluid circulates in a closed circuit, from the first interface port 21 to the first cable length 1 (particularly located to the left in FIG. 11), to return via the second cable length 1 (particularly located to the right in FIG. 11) to the second interface port 21. For example, the cooling fluid exits through one of the interface ports 21, is cooled and pressurised in a cooling system, and then re-injected through the other interface port 21. This is particularly advantageous for managing systems spanning long distances, where drops in pressure and increases in the temperature of the cryogenic fluid may occur.

FIG. 12 shows an electrical system S that comprises an example of a superconducting cable assembly provided with a branch terminal 13. Electrical equipment 24 is connected to the branch terminal 13 of the superconducting cable assembly to exchange current with the cable assembly. The cable assembly may furthermore be connected to terminals 23 at its ends. In particular, the terminals 23 provide a connection with a conventional electrical network operating at ambient temperature. The electrical equipment 24 is, for example, a renewable energy source, such as a photovoltaic panel or farm, or a wind turbine or wind farm. The electrical equipment 24 may be an electrical consumer powered by the superconducting cable, for example, a data centre. The electrical system S may comprise any of the examples of cable assemblies described above.

Preferably, the electrical system S comprises:
one or several superconducting cable assemblies each comprising several cable joints each comprising an electrical branch terminal 13;
several renewable energy sources (such as photovoltaic panels of a solar farm or wind turbines of a wind farm) each electrically connected to one of the electrical branch terminals 13.

This arrangement facilitates the connexion of the renewable energy sources to the electrical network they supply, especially when said renewable energy sources belong to a farm.

In all of the embodiments described in this case, the internal conductive part 14, respectively the external conductive part 14′, of the electrical connection 12 may be ring-shaped coaxial with the electrical junction; the internal wall 7 of the insulation junction 70, respectively the external wall 7′ of the insulation junction 70, comprising an electrically insulating part 8, 9, tubular in shape coaxial with the ring, on either side of the ring.

1. A superconducting cable assembly provided with an electrical branch terminal,
said assembly comprising a first cable length and a second cable length, each cable length coaxially comprising a superconducting element, a cryostat, a screen, an external enclosure defined by an internal wall and an external wall and providing thermal insulation,
said assembly further comprising a cable joint comprising:
an electrical junction providing an electrical connection of the superconducting elements of the first cable length and of the second cable length,
an insulation junction comprising an internal wall and an external wall providing thermal insulation, said insulation junction defining a connection chamber wherein said electrical junction is located,
said electrical branch terminal being located on an external surface of the insulation junction and being connected to said electrical junction by an electrical connection sealingly passing through said insulation junction;
the electrical connection comprising an internal conductive part located in the internal wall of the insulation junction and an external conductive part located in the external wall of the insulation junction, the internal conductive part being connected, on the one hand, to the electrical junction by a flexible electrical connection device extending through the connection chamber, and, on the other hand, to the external conductive part by a flexible electrical connection device extending between the internal wall and the external wall of the insulation junction;
the internal conductive part, respectively the external conductive part, of the electrical connection being ring-shaped; the internal wall of the insulation junction, respectively the external wall of the insulation junction, comprising an electrically insulating part on either side of the ring.

2. The assembly according to claim 1, wherein the screens of the first cable length and the second cable length are electrically connected to the insulation junction.

3. The assembly according to claim 1, comprising at least one secondary branch terminal located on the external surface of the insulation junction and connected to the screen of the first cable length or to the screen of the second cable length via an electrical connection sealingly passing through said insulation junction.

4. The assembly according to claim 1, wherein the internal wall of the insulation junction connects the internal walls of the external enclosures of the first and second cable lengths and the external wall of the insulation junction connects the external walls of the external enclosures of the first and second cable lengths, so as to provide a continuous connection between the external enclosures of the first cable length and the second cable length.

5. The assembly according to claim 1, comprising a plurality of first cable lengths and a plurality of second cable lengths respectively connected by the cable junction,
the connection chamber of the insulation junction comprising a plurality of electrical junctions respectively connecting one of the plurality of first cable lengths with one of the plurality of second cable lengths.

6. The assembly according to claim 1, wherein each cable length (1) has its own external enclosure, or the first cable lengths have a common external enclosure and the second cable lengths have a common external enclosure.

7. The assembly according to claim 1, wherein the cable junction comprises a cryostat comprising said connection chamber,
said connection chamber being in fluidic connection with the cryostat of one among the first cable length and the second cable length, a sealed wall insulating said connection chamber of the cryostat from the other cable length,
a first cooling fluid interface port being located on one side of the sealed wall and passing through the insulation junction to open out into the connection chamber,
a second cooling fluid interface port being located on the other side of the sealed wall and passing through the insulation junction for a fluidic relationship with the cryostat of the other cable length.

8. The electrical system comprising:
one or more superconducting cable assemblies provided with a branch terminal according to claim 1, said cable assemblies being in series;
one or more items of electrical equipment, respectively connected to a branch terminal of the superconducting cable assembly/assemblies, the electrical equipment being, in particular, one or more sources of renewable energy.
